(19) United States
(12) Patent Application Publication
(10) Pub. No.: US 2010/0003930 A1
(43) Pub. Date: Jan. 7, 2010

(54) Personal content player

(76) Inventors: Thomas N. Giaccherini, Carmel Valley, CA (US); Edward F. Tuck, West Covina, CA (US); James Riley Stuart, Louisville, CO (US); David Lacis Payne, Morgan Hill, CA (US); Rebecca Weeks Watson, Kentfield, CA (US)

Correspondence Address: Thomas N. Giaccherini, Post Office Box 1146, Carmel Valley, CA, 93924, US

(21) Appl. No.: 12/455,963

(22) Filed: Jun. 4, 2009

Related U.S. Application Data
(60) Provisional application No. 61/131,749, filed on Jun. 10, 2008.

(51) Int. Cl. H04B 1/40; G06Q 30/00; G06Q 50/00

(52) U.S. Cl. 455/74; 705/14.64; 705/14.61

(57) ABSTRACT

A Personal Content Player is disclosed. One embodiment of the present invention is a miniature electronic device which functions as an automatic content receiver and storage device. Digital content is transmitted to the device using the excess capacity in an existing network, such as one or more conventional broadcast radio stations. The content is received by the device, and stored in a memory. The content is then played at a time chosen by the user.

### CROSS-REFERENCE TO A PENDING PROVISIONAL PATENT APPLICATION & CLAIMS FOR PRIORITY

This Non-Provisional Patent Application is related to a Pending U.S. Provisional Patent Application Ser. No. 61/131,749, filed on 10 Jun. 2008. The Applicants claim the benefit of priority for any and all subject matter which is common to the Pending Provisional Patent Application and in the Present Patent Application under 35 USC Sections 119 and/or 120.

The Applicants also claim the benefit of priority for any and all subject matter which is commonly disclosed in the Present Patent Application and in Pending U.S. Ser. No. 12/315,367, entitled Personal Digital Asset Manager, filed on 1 Dec. 2008.

### FEDERALLY SPONSORED RESEARCH OR DEVELOPMENT

None.

### FIELD OF THE INVENTION

The present invention pertains to methods and apparatus for a Personal Content Player. One embodiment of the present invention is a miniature electronic device which functions as an automatic content receiver and storage device. Digital content is transmitted to the device using the excess capacity in an existing network, such as one or more conventional broadcast radio stations. The content is received by the device, and stored in a memory. The content is then played at a time chosen by the user. In one embodiment, the present invention may be held by a keyring, carried in a pocket or purse, clipped to a belt, or incorporated into a pair of eyeglasses.

### BACKGROUND OF THE INVENTION

In the past few decades, a vast array of new electronic devices designed for communicating and for playing digital content have become widely available. The total number of cellular telephones in use around the world in 2006 exceeded two billion. The total cumulative sales of personal computers worldwide will exceed two billion in the year 2008. In the past few years, millions of MP3 players have been sold.

Enormous quantities of content are available on the Internet, but this content must be located by searching and then downloaded to the user's personal computer, cellular telephone, MP3 or MP4 player. In many cases, this content is contained in large files which require long download times, even when a high speed connection is available.

No current device that is generally commercially available which may be used to continuously and automatically receive and store digital content without requiring the action or direction of the user, which would enable users to enjoy stored content at a time which they select.

The development of a device that would offer these capabilities would constitute a major technological advance, and would satisfy long felt needs and aspirations in the entertainment and telecommunications businesses.

### A BRIEF DESCRIPTION OF THE DRAWINGS

FIG. 1 reveals one embodiment of the present invention, the Watchman™, a wireless hand-held electronic content receiver and storage device. The Trademark Watchman™ is used and owned by the Assignee of the Present Patent Application, Pascal's Pocket Corporation.

FIG. 2 provides a front view of one embodiment of the invention, which shows a viewing screen, a speaker and user controls.

FIG. 3 supplies a side view of one embodiment of the invention, which reveals a battery compartment located on the back side of the device.

FIG. 4 depicts one method of the present invention, which uses a conventional AM radio station to broadcast a generally continuous and automatic stream of content. The content is conveyed to the radio station from a content provider, and is then broadcast using the excess capacity in the conventional signal. A radio receiver and antenna in the Watchman™ device are tuned to receive this content without any user action or intervention. The stream of content is stored in a memory, and the content is played at a time chosen by the user.

FIG. 5 reveals some details of the broadcast signal from the radio station. While conventional devices receive the primary or main signal, the Watchman™ is tuned to receive the stream of content conveyed by a subcarrier or sideband.

FIG. 6 portrays point-to-multipoint broadcasting. In this embodiment, every user within the broadcast range of the radio station receives the same stream of content.

FIG. 7 is a pictorial view of the electronic components inside one embodiment of the present invention.

FIG. 8 offers a generalized schematic block diagram of the components comprising a second, more advanced embodiment of the present invention.

FIG. 9 shows a Watchman™ being given away as a promotion at a fast food restaurant.

FIG. 10 shows a Watchman™ being given away as a gift at a movie theater.

FIG. 11 shows a Watchman™ being given away as an incentive at a retailer.

FIG. 12 exhibits one method of the invention, which comprises:

uploading cost-free, uncopyrighted content from content creators to a content aggregator;

supplying personal content players from a manufacturer to a sponsor/distributor;

furnishing advertising from an advertising agency to the sponsor/distributor;

distributing personal content players to customers; and

conveying free content and advertising to customers wirelessly and automatically.

FIG. 13 supplies a view of an alternative embodiment which includes solar cells to provide power.

FIG. 14 shows a private network which is operated by a retail store. Customers enjoy content delivered via this private network on their Watchman™ terminals.

FIG. 15 depicts the inside of a retail store, where a private network delivers content that pertains to products that are on sale in the retail store.

FIG. 16 furnishes a view of an alternative embodiment, a Watchman™ NanoCaster™, which includes a radio receiver and a USB port.

FIG. 17 shows how a NanoCaster™ may be connected to an iPod or other MP3 or MP4 player.

FIGS. 18A and 18B reveal alternative embodiments of the NanoCaster™.

FIG. 19 is a schematic diagram of one embodiment of the NanoCaster™.

FIG. 20 offers a view of a nationwide NanoCaster™ Network.

FIG. 21 illustrates another alternative embodiment of the invention, which includes a return channel for short messages.

### A DETAILED DESCRIPTION OF PREFERRED & ALTERNATIVE EMBODIMENTS

### I. Preferred & Alternative Embodiments of the Invention

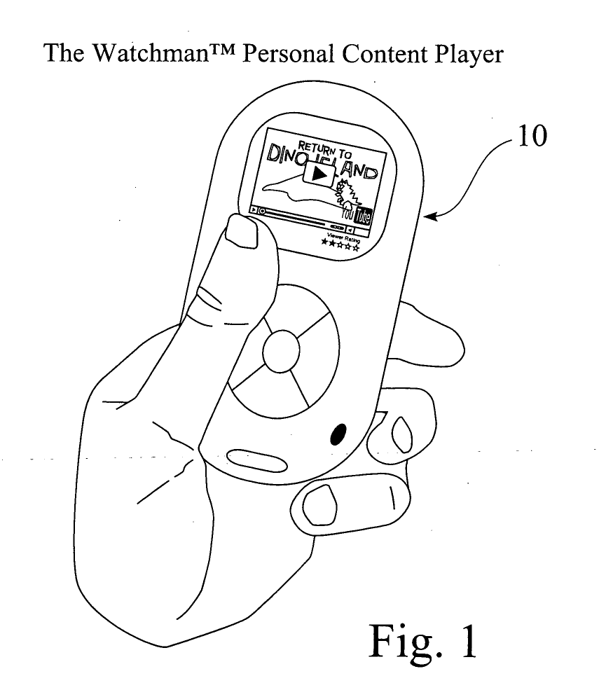

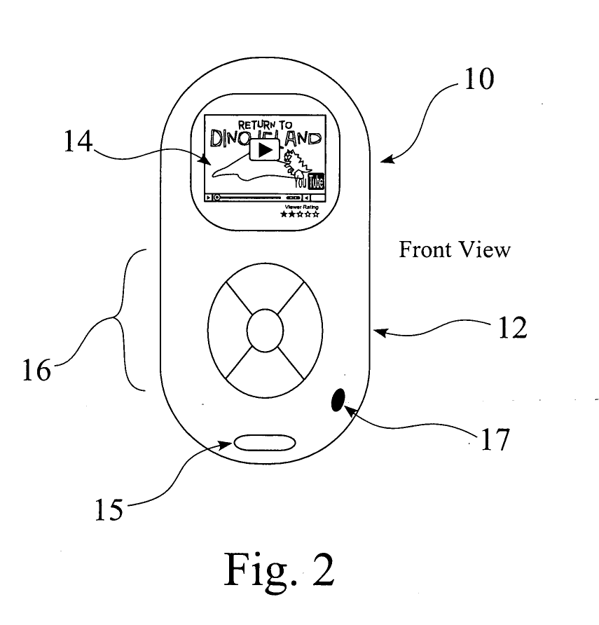

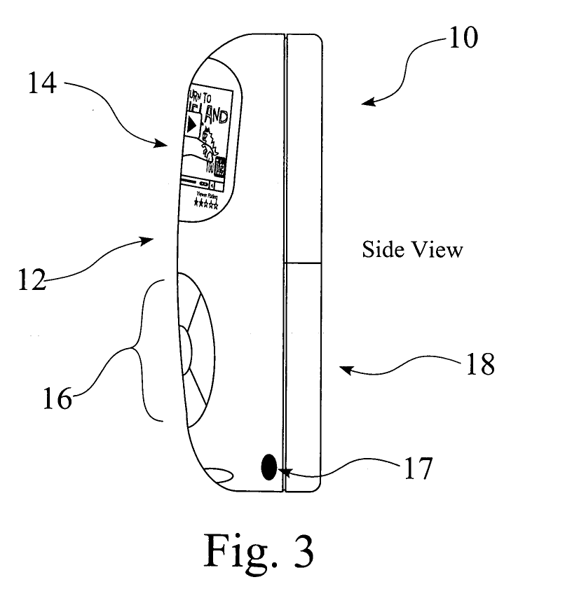

FIG. 1 provides a pictorial view of one embodiment of the present invention 10, the Personal Content Player, which comprises a hand-held electronic wireless device for receiving, storing and playing digital content. FIG. 2 supplies a front view of this embodiment 10, which includes a housing or enclosure 12, a viewing screen 14, a speaker 15 for reproducing audio, a set of user controls 16 and a headphone jack 17. In this embodiment, the housing 12 is fabricated from plastic or some other suitable material. In the embodiment shown in FIG. 2, the viewing screen 14 is a miniature organic light emitting diode (OLED) display or some other suitable component for displaying a still image, a video, a movie or some other visual output. As shown in FIG. 2, user controls 16 comprise buttons, pads or other appropriate control devices for on/off functions, as well as play, pause, stop, skip, fast forward, rewind or change channels. FIG. 3 offers a side view, and reveals a battery compartment 18 on the back side of the invention.

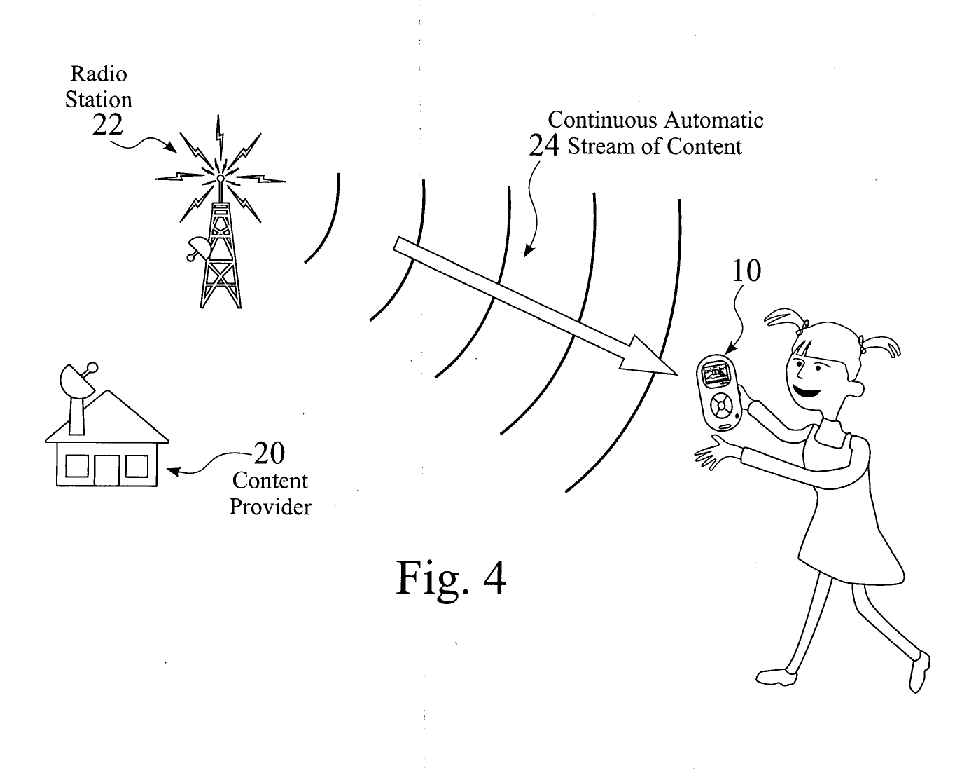

FIG. 4 depicts the general operation of one embodiment of the invention. A content provider or aggregator 20 generally contains or receives selections or programs of digital content, which mazy or may not be copyrighted or otherwise restricted. In this Specification and in the Claims that follow, the terms “selection” and “program” refer to discrete segments or portions of content. In one embodiment, the digital content comprises audio and video clips that are uploaded to various Internet websites by individuals. These content providers or aggregators 20 may include websites such as YouTube, Blip.tv, VideoEgg, Dailymotion, Veoh, Grouper, Jumpcut, Eyespot, Fligz, Openvlog, Revver, ManiaTV or other sites. In an alternative embodiment, the content provider 20 may produce its own content. The content provider or aggregator 20 transports content to one or more broadcast terminals 22, such as a conventional radio station 22. In one embodiment, one or more AM or FM radio stations 22 are employed to provide a generally continuous stream of content 24 from the content provider or aggregator 20. In alternative embodiments, a cellular base station, Wi-Fi, WiMAX or some other suitable transmitter may be used to convey the content. The content is delivered using the excess capacity of the transmitter 22. In this embodiment, the digital content is conveyed in a sideband or subcarrier of the AM radio signal. In another embodiment, the digital content is conveyed during temporary transmissions of, or embedded in, the main radio signal. The content may be encrypted so that only authorized receivers 10 can receive content. A more detailed description of the content distribution method, which is called the RainBarrel™ Method, is described in Section II.

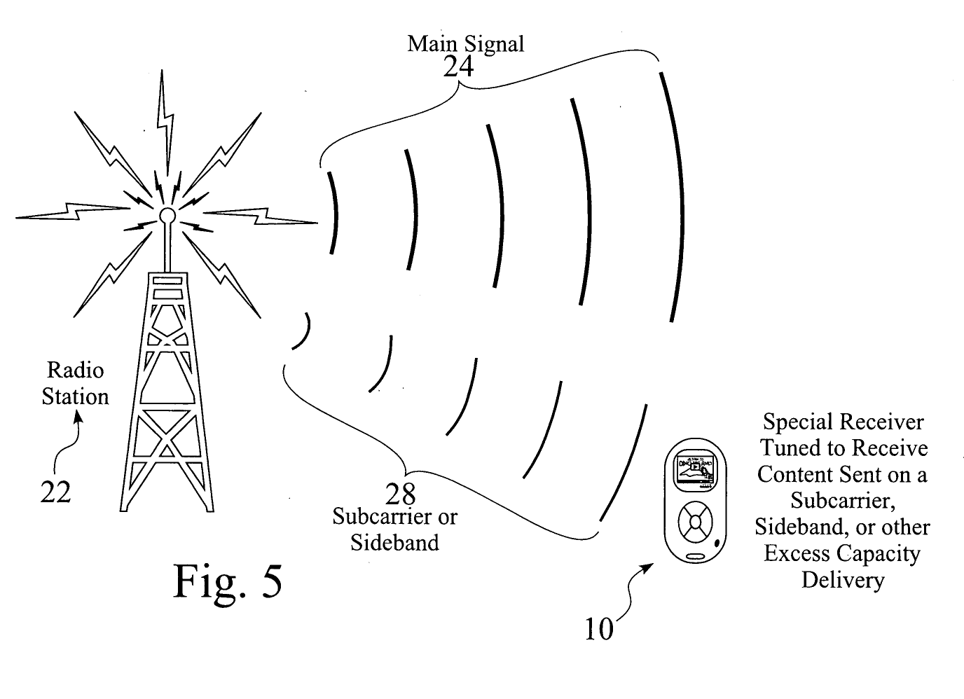

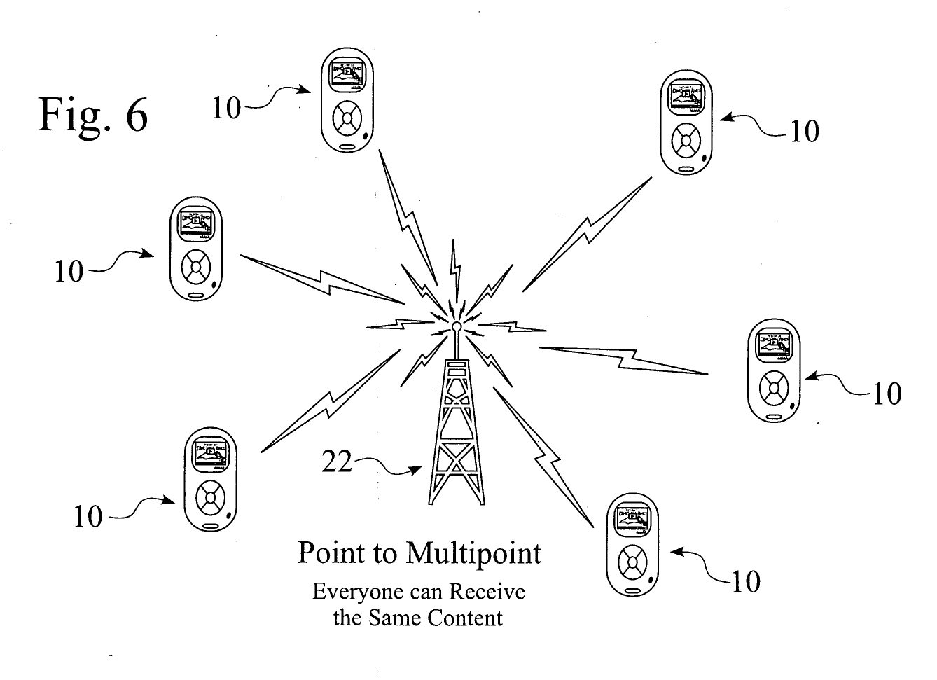

FIG. 5 portrays the transmission of two separate broadcast signals: a main signal 24, which is received and reproduced by conventional receivers; and a subcarrier or sideband signal 28, which is received, accumulated and reproduced by the present invention using a specially-tuned receiver. FIG. 6 depicts the architecture of one embodiment of the present invention, which utilizes point-to-multipoint communications. Every receiver 10 within the footprint of the transmitter 22 is capable of receiving the same stream of broadcast content, which results in an extremely low-cost means of content distribution. In an alternative embodiment, more than one subcarrier or sideband may be used to transmit separate and different channels of content. In yet another embodiment, more than one transmitter may be used to broadcast many different channels of content. Each receiver 10 may be tuned to receive one or more specific streams of content. Each receiver 10 may also be configured to accumulate and store signals which are specifically coded for a particular set of receivers.

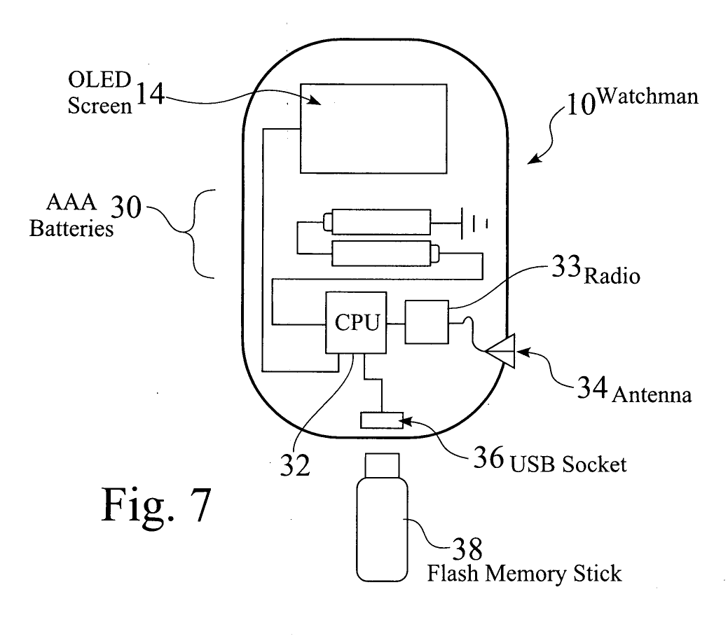

FIG. 7 furnishes a schematic illustration of the components inside one particular embodiment of the present invention. This embodiment includes an OLED screen 14, AAA or other suitable batteries 30, a CPU 32, an AM radio sideband or subcarrier receiver 33 with a ferrite bar antenna 34 and a external memory socket 36 for a flash memory 38. The radio receiver 33 is generally configured to receive only a stream of content which is broadcast using the excess capacity in a broadcast signal. In this embodiment, the radio receiver is also configured to strip out and decode the content, and then sends the content to the memory. In this embodiment, the memory socket 36 is a USB port which is adapted to receive a USB flash memory drive. This embodiment may be distributed to users without batteries 30 and without the flash memory 38 to minimize manufacturing and distribution costs. In this embodiment, the user supplies both batteries 30 and a flash memory 38. In another embodiment, the batteries are disposable, and may or may not be rechargeable. In yet another embodiment, the batteries may be rechargeable using the USB port 36. In still another embodiment, the batteries may be rechargeable using solar cells.

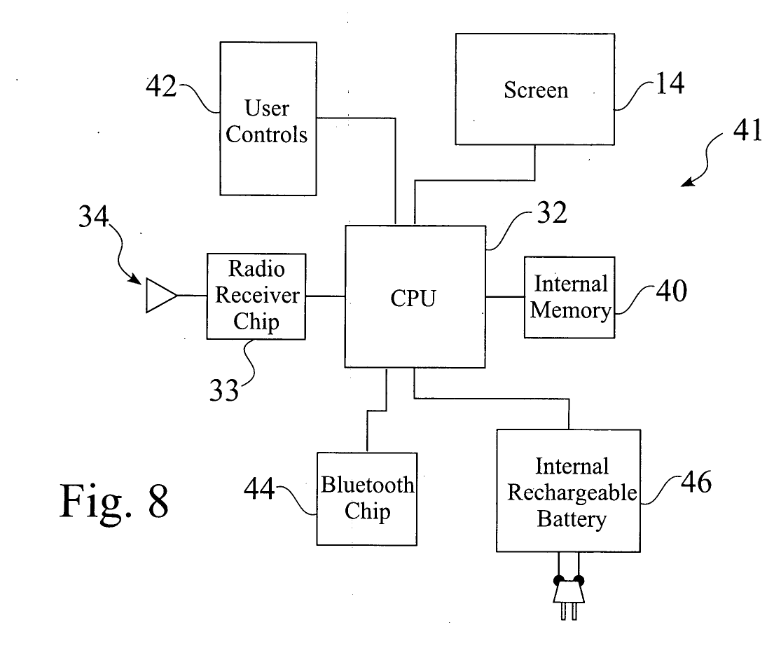

FIG. 8 offers a schematic block diagram of an enhanced embodiment of the present invention. The block diagram 41 includes a viewing screen 14, an antenna 34, an internal memory 40, user controls 42, a transmitter circuit 44 and an internal rechargeable battery 46 connected to a radio receiver circuit 33. The transmitter 44 is used to convey content wirelessly from this embodiment of the Personal Content Player 10 to a television, computer monitor or some other suitable display. In one embodiment, this transmitter 44 is a Bluetooth or Wi-Fi device, and transmits to a corresponding Bluetooth or Wi-Fi device on the remote display where content is viewed.

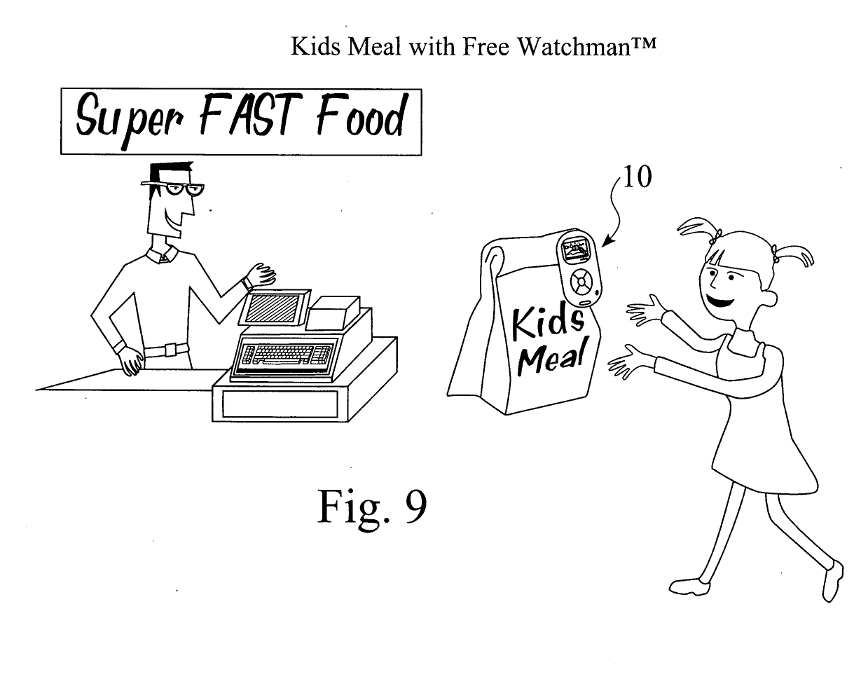

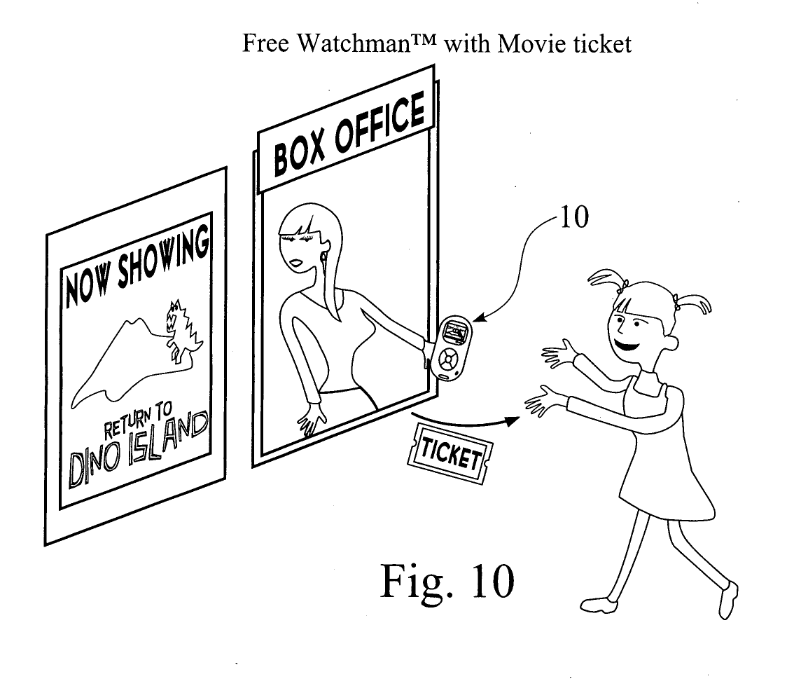

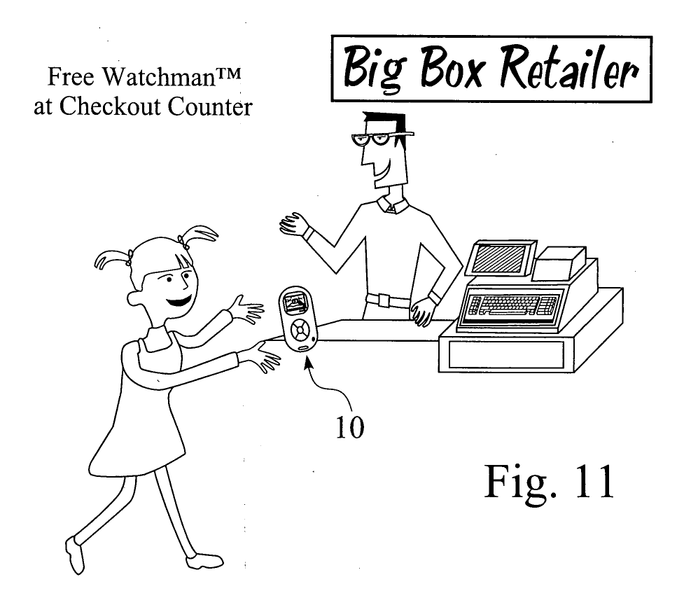

FIGS. 9, 10 and 11 depict the distribution of one embodiment of the present invention as a gift that accompanies the purchase of a meal, a movie ticket or other retail transaction.

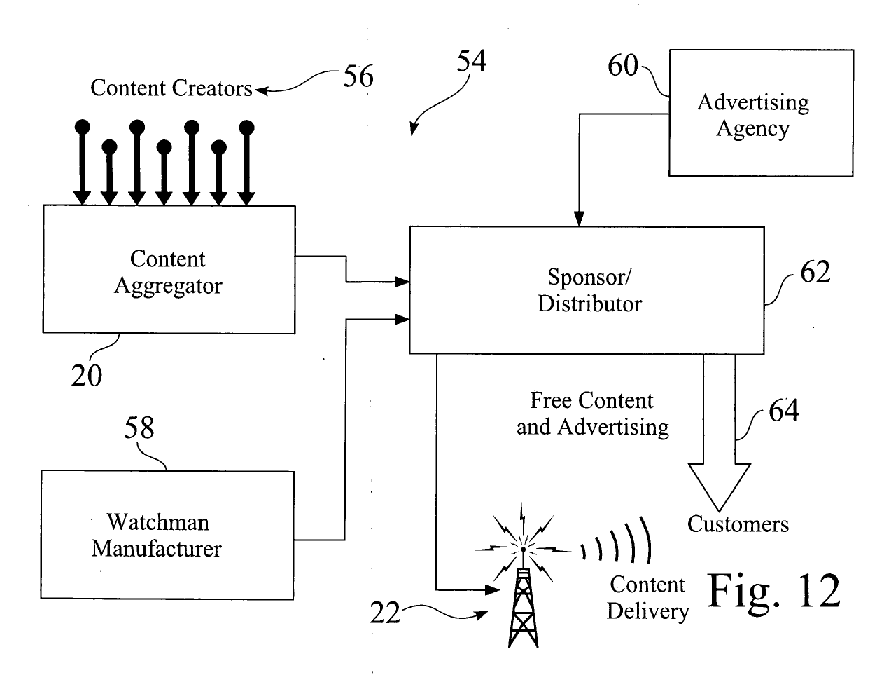

FIG. 12 is a block diagram 54 that depicts one method of the present invention. Content creators 56 generate content and upload or otherwise convey their content to a content aggregator 20, such as YouTube. In one embodiment, this upload is accomplished using the Internet. A manufacturer 58 produces Watchman™ devices, like the ones illustrated in any of the FIGS. 1-11, and delivers them to a sponsor or distributor 62, such as McDonald's, Disney or Wal-Mart. An advertising agency 60 provides advertising in the form of video and audio messages. One or more transmitters 22 may be used to convey a mixture of free content and advertising 64 to customers who have received Watchman™ devices from a sponsor or distributor 62. The sponsor 62 may be a movie studio, theater, movie distributor or some other entity which wishes to provide promotions or gifts to its customers.

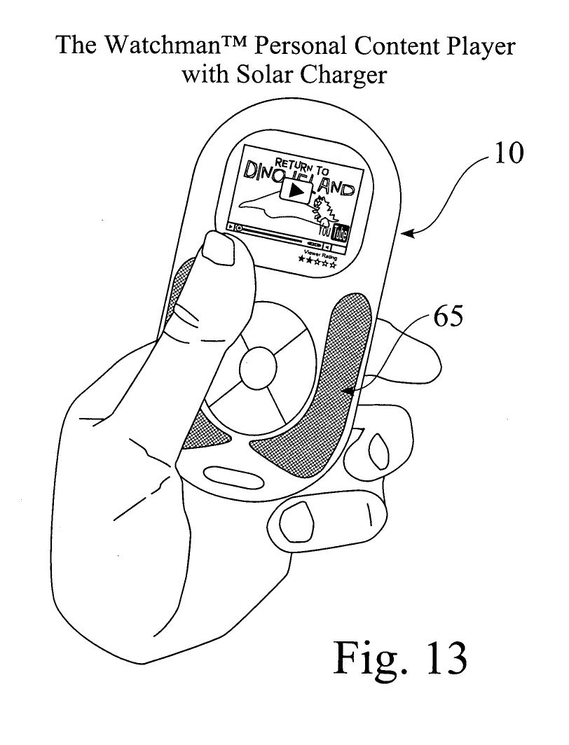

FIG. 13 offers a view of an alternative embodiment, which includes solar cells 65 for providing power.

In one embodiment of the invention, the advertisement is not part of the broadcast. Various advertisements may be included in memory at manufacture and inserted automatically and periodically into content.

### II. The RainBarrel™ Method

The present invention comprises methods and apparatus for delivering high quality digital signals to residential or other subscribers using the unused, excess capacity that is inherent in virtually all communication networks. These methods and apparatus are described in detail in Pending U.S. patent application Ser. No. 09/579,324, filed on 25 May 2000 and entitled Method for Utilizing Excess Communications Capacity; and in corresponding PCT International Patent Application Number PCT/US01/14828, PCT Publication No. WO 01/93457, filed 23 May 2001. Both of these publications are hereby incorporated by reference in their entirety into the Present Patent Application.

In one embodiment, digital content is conveyed using the excess capacity in a network. This content may be delivered using AM or FM broadcast systems. The methods of delivery are described in further detail below. The content may be organized in packets, and the transfer of packets may be accomplished using asynchronous transfer methods, so that the packets are then routed to, and resequenced in order, at their final destination.

### Data Delivery Methods on Existing Communications Channels

### Local, Standard Data Delivery Methods

Several direct-to-home (DTH) data delivery methods are currently available. These methods use standard broadcast transmissions over existing communications channels and networks. Some of these are Very High Frequency (VHF) and Ultra High Frequency (UHF) Television Broadcast Channels, Amplitude Modulation (AM) Broadcast Station Channels, Frequency Modulation (FM) Broadcast Station Channels, Satellite Television Receive Only (TVRO), Satellite Direct Broadcast Systems (DBS, DSS, or DTH), and Cellular Digital Packet Data (CDPD). Data signals may be received directly by a subscriber on his/her wireless antenna, or through a cable system.

### AM Broadcasting Station Channels

The amplitude modulation (AM) radio broadcast band in the United States ranges from 535 to 1705 kHz. It is divided into 117 channels of 10 kHz bandwidth each. Center frequencies in kHz are given by:

f₀=540+(n×10) KHz, for n=0 to n=117 Equation (1)

AM broadcasting stations transmit at various powers depending on their license, and, in some cases, the time of day. The nominal power authorized ranges from 250 watts to 50 kilowatts. See 47 CFR 73.14. The station's owner has considerable freedom in the signals he transmits, so long as he does not interfere with adjacent channels or other services. See 47 CFR 73.1690(e). In the US, 47 CFR 73.127 authorizes AM broadcast stations “to transmit signals not audible on ordinary consumer receivers, for both broadcast and non-broadcast purposes.”

One implementation of data delivery using AM broadcasting stations is a subcarrier at the channel center frequency modulated by a 256-Quadrature Amplitude Modulation (QAM) waveform, with shape factor 1.25, at 8 kilobits per second (kbps). This provides a 64 kbps transmission rate of raw data. The symbols are trellis-coded at rate ⅞ to provide forward error correction, resulting in a data rate of 56 kbps. The data are partitioned into 512 byte (4,096 bit) packets. The first 16 bytes of each packet are used for synchronization, address and flag fields. The remaining 496 bytes contain data. The resulting data transmission rate is 54.25 kbps, or 585.9 MBytes per day for each AM radio station.

The invention may also employ AM subcarriers. In the U.S., 47 CFR 73.127 authorizes AM broadcast stations to transmit subcarriers.

### FM Broadcast Station Channels

The frequency modulation (FM) broadcast band in the United States ranges from 88 to 108 MHz. The band is divided into 100 channels of 200 kHz bandwidth each. The channel center frequencies are given by:

f₀=88.1+(n×0.2) MHz, where n=0 to n=99 Equation (2)

In the U.S., 47 CFR 73.293 authorizes FM broadcast stations to “transmit subcarrier communications services.” One implementation of data delivery using FM radio broadcasting stations is a subcarrier at the channel center frequency modulated by a shaped-offset, Quadrature Phase Shift Keying (QPSK) waveform, with shape factor of 1.25, at 80 kbps. This provides a 160 kbps transmission rate of raw data. The delivered data are partitioned into 512 byte (4,096 bit) packets. The first twelve bytes of each packet are used for synchronization, address and flag fields. The remaining 500 bytes contain payload data with rate ⅘ turbo code, FEC. The resulting data transmission rate is 125 kbps, or 1.35 gigabytes (GBytes) per day for one FM broadcasting station.

### Satellite TV, TVRO

In the United States, Satellite TV operates in the C-band (3-7-4.2 GHz) and in the Ku-band (11.7-12.2 GHz), Fixed Satellite Service (FSS) allocations. These are so-called “big dish” systems. One implementation of data delivery using Satellite Television Receive Only (TVRO) transmissions uses the same scheme described above for the VHF and UHF television broadcast stations.

### Satellite DBS, DSS or DTH

The Direct Broadcast Satellite Service band in the United States ranges from 12.2 to 12.7 GHz. The DIRECTV™ system provides up to 30 Mbps of FEC-protected data, depending on the code rate selected for each transponder. Each transponder typically provides three to eight video channels, depending on content. One entire transponder used for transmitting data in the present invention would provide 324 GBytes of data per day.

### Cellular CDPD

The Cellular Digital Packet Data (CDPD) network provides digital data over existing North American cellular networks by taking advantage of the idle time on analog AMPS channels to transmit packet data at 19.2 kbps. There are 666 AMPS channels between 870 and 890 MHz in the forward direction, and between 825 and 345 MHz in the reverse direction. The channels have 30 kHz bandwidths. There are 42 radio frequency (RF) control channels which cannot be used for CDPD. The CDPD standard specifies Gaussian Minimum Shift Keying (GMSK), and is modulated with a bandwidth time product (BT) of 0.5. CDPD supports two-way communication, so only minimal FEC is required. Allowing 1.2 kbps for packet overhead and FEC, there remain eighteen kbps for data transmission, or 194 MBytes of data per day, per cellular channel used.

### Local, Non-Standard Data Delivery Methods

Other local direct-to-home (DTH) data delivery methods are available, and may be based on non-standard uses of existing communications channels and networks. These are: Television Vertical Blanking Interval (VBI); Television Aural Band Subcarriers; AM Subcarriers; and FM Subcarriers. These signals may be received directly by a subscriber on his/her wireless antenna, or through a cable system.

### FM Subcarriers

47 CFR 73.293 authorizes FM broadcast stations to “transmit subcarrier communications services in the United States.” Broadcast FM stations have been using subcarriers since the 1950's for things like Muzak music delivered to individual and company subscribers. Data broadcasting is more recent, but already in use for things like differential Global Positioning System (GPS) corrections, traffic data, stock quotes, etc.

One implementation of data delivery by FM subcarrier is the Radio Broadcast Data System (RBDS). A 57 kHz subcarrier is used, which is amplitude modulated by shaped biphase, differentially-coded, encoded digital data at 1.1875 kbps. The baseband data is packetized into groups of 104 bits. Each group is divided into 4 blocks of 26 bits each, and each block is further divided into 18 data bits and 10 check bits. This results in a 0.615 code rate, and a 730.8 bps information rate. Data transmission of this type is 7.9 MBytes per day.

Another implementation is Data Radio Channel (DARC). A 76 kHz Level Minimum Shift Keying (LMSK) subcarrier, modulated at 16 kbps raw bit rate, is injected into the composite FM signal at 10% modulation (−20 dB). The 16 kbps raw bit rate is equivalent to 173 MBytes per day. Adding frame and address overhead at 20%, and rate-forward error correction, a data rate of 10 kbps, or 108 MBytes per day can be achieved. A more efficient modulation scheme can provide a 56 kbps raw bit rate, equivalent to a 35 kbps data transmission rate, or 378 MBytes of data delivery per day per FM station.

### National or Regional Long-Haul Data Delivery Method (VSAT)

Satellites may be used to deliver data to national or regional destinations. Long-distance data delivery to local, “last-mile” data sources is implemented by leasing existing Low Earth Orbiting Satellite VSAT communications channels. For example, a 10 MHz subcarrier slice of the capacity of a single transponder covering the United States on a pre-emptible basis is both inexpensive and readily available. In the U.S., Satellite VSAT operates in the C-band (3.7-4.2 GHz) and Ku-band (11.7-12.2 GHz) Fixed Satellite Service (FSS) allocations.

Data transmission rates for transponders was described above in the section discussing the Direct Broadcast Satellite Service.

The present invention may be utilized to transport any kind of data during the non-peak hours or under-utilized periods of operation of a satellite network. The RainBarrels^{SM} Method, which enables the accumulation of data using excess capacity, may be implemented using a network of conventional copper land-lines, fibers, broadcast or microwave towers, cellular, PCS or any other suitable links or connections. The invention may be practiced using the Internet and TCP/IP or UDP/IP, over public switched telephone networks or over a private data network.

### Wi-Fi & WiMAX

The invention may also employ Wi-Fi, WiMAX or other suitable wireless broadband services.

### III. Alternative Methods of Transmission

The present invention may be implemented using a variety of alternative methods, apparatus and systems. Some of these are described below:

U.S. Pat. No. 5,937,000 describes a Method and Apparatus for Embedding Auxiliary Data in a Primary Data Signal. According to Lee et al.:
“Auxiliary data is transported in a primary data signal by hiding the data in the form of colored noise. The colored noise has a spectrum that simulates the spectrum of the primary data signal. The data to be transported is first converted to a spread spectrum signal. The primary data signal is analyzed to determine its spectral shape. The same spectral shape is imparted to the spread spectrum signal, which is then combined with the primary data signal for transmission”

Acoustic Communication with OFDM Signal Embedded in Audio (Audio Engineering Society, September, 2006) According to Matsuoka et al.:
“This paper presents a method of aerial acoustic communication in which data is modulated using OFDM (Orthogonal Frequency Division Multiplexing) and embedded in regular audio material. It can transmit at a data rate of about 1 kbps, which is much higher than is possible with other data hiding techniques. In our method, the high frequency band of the audio signal is replaced with OFDM carriers, each of which is power-controlled according to the spectrum envelope of the audio signal”

Audio Data Hiding with Application to Surround Sound Acoustics, Speech, and Signal Processing, 2003. Proceedings. (ICAS SP apos; 03). Volume 2, Issue, 6-10 April 2003 Page(s): II-337-40. According to Chou et al.:
“Summary: There has been a lot of interest recently in applying channel coding with side information (CCSI) concepts to data hiding. Part of the interest stems from the fact that information theoretic bounds can be derived for such systems. In this paper, we model the audio data embedding problem as a parallel CCSI problem. This is done by dividing the audio spectrum into frequency bins and then treating each bin as a separate CCSI channel. A perceptual mask is derived from the audio signal to determine the amount of power to use in each channel. It acts as a “water-filling” formula by determining the amount of distortion that can be introduced into each frequency bin without introducing audible distortion. As a result, our data embedding scheme will be imperceptible to the human ear. An exciting application for our audio data embedding solution is to embed data within the audio signal that will enable surround sound at the receiver. The resulting surround sound system will be better than existing surround sound systems that are based on manipulating two stereo channels to derive the other surround channels.”

Wikipedia article: Radio and Broadcast: Independence from the Transmission-Medium.
“The system is independent of the underlying transmission-medium. Any transmission-medium with an audio signal can transmit embedded data, including AM/FM radio-stations, terrestrial TV, satellite TV, internet-radio, etc. Internet radio-stations could embed data into their audio signal, so that it can be streamed via the internet to anywhere in the world, then without modification, re-broadcast by radio to a local area or a whole country . . . . ”

### Overcoming Propagation Problems

In general, standard broadcast AM reception is poor where there are conducting materials around: under overpasses, under power lines, and in steel-framed buildings. The wavelength of a 1,000 KHz signal, in the middle of the broadcast band, is 300 meters. Radio signals will not generally propagate through a hole smaller than ¼ wavelength, so a 1,000 KHz broadcast signal is strongly attenuated after passing through an aperture smaller than 75 meters. The problem is more sever at the low-frequency end of the broadcast band. A station broadcasting on 540 KHz has a wavelength of 555 meters, and thus suffers severe attenuation in passing through an aperture of 139 meters or smaller.

FM broadcast signals, in the 88 to 108 MHz range, have much better penetration: their longest wavelength is 3.4 meters, thus FM broadcasts usually propagate well in a steel building, but not around corners.

To avoid dropouts in the content, several methods may be employed. In one embodiment, two identical streams of data are transmitted. A “backup signal” is also transmitted, and may be delayed by several minutes. In this embodiment, he Watchman™ is configured to reestablish connection later, and fill in data that is missing due to a signal drop-out.

Alternatively, and in the above case if the delay is long, the Watchman™ could simply delete the missing section. If the content is a short clip, the entire clip is deleted; if the content is a movie, then a message is inserted, and resumed when the signal is reaquired.

### IV. Security

All communications to and/or from the invention may be protected with security systems which thwart or eliminate fraud or misuse. In one embodiment of the invention, security is provided by the UltraSecure^{SM} System, which uses “Electronic DNA” embedded in the device and in remote servers and the user's biometric input to prevent fraud, ID theft, viruses, malware and spam. The UltraSecure^{SM} System is described in U.S. patent application Ser. No. 09/887,570, filed on 22 Jun. 2001, and in PCT International Patent Application No. PCT/GB02/05612, filed on 11 Dec. 2002. Both of these Published Patent Applications are hereby incorporated by reference.

### Bilateral and Multilateral UltraSecure^{SM} Security System

In one embodiment of the invention, the UltraSecure^{SM} System comprises Server-side software acting as encryptor for source content and a Client-side software acting as the decryption and re-assembler of the content. Two (Bilateral) or more (Multilateral) devices may be entwined with a dual asynchronous communication path wherein both the Client and Server side portions of the software are installed and registered for both devices (whether in a Ops Center or a Field/Consumer device). Such entwinement enables the use of the UltraSecure Transaction Protocol (USTP) to provide the highest level of communication, content and session security between the two devices, to fully protect data on the device, data in being transferred, data in the host, or data backups being transferred over non USTP protocol systems. Applications include secure two-way communication, remote computing and backups, network transactions (e-mail, web, fund transfers, etc), and access to secured resources (facilities, data information, etc).

### V. Alternative Embodiment: A Private Television System

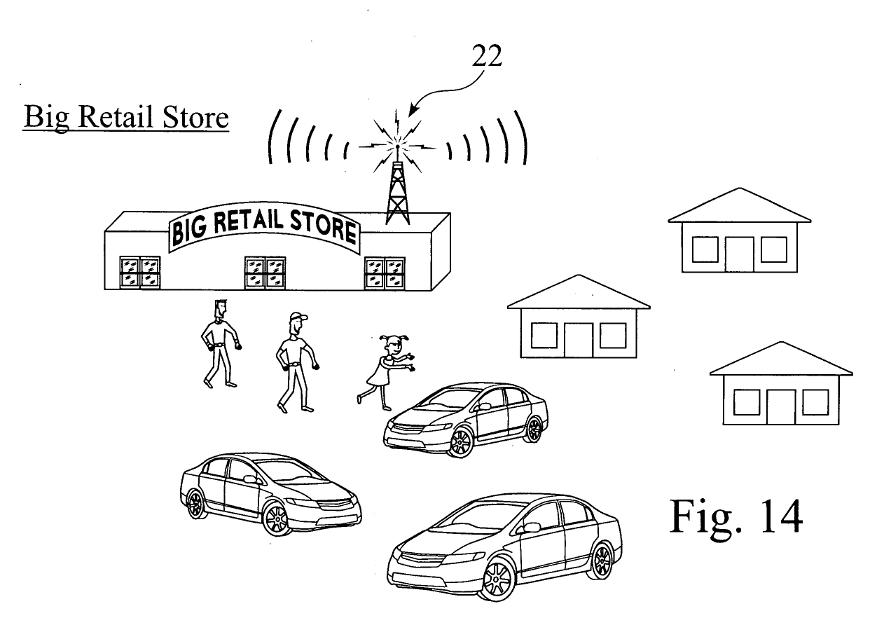

In yet another embodiment of the invention, FIG. 14 shows how a retailer or some other entity may create a private television distribution system to continuously push content to the Watchman™ using the RainBarrel™ Method. An antenna may be erected atop a retail store which includes a low power radio transmitter. This radio or “hub” may use Wi-Fi, WiMAX, AM, FM, cellular or any other suitable frequency for transmissions.

In this embodiment, content may include advertisements; information about products or special discounts, sales or prices; entertainment; “how-to” or instructional videos; or any other program chosen by the operator of the transmitter. The Watchman™ may be distributed to customers in the retail stores as they check-out.

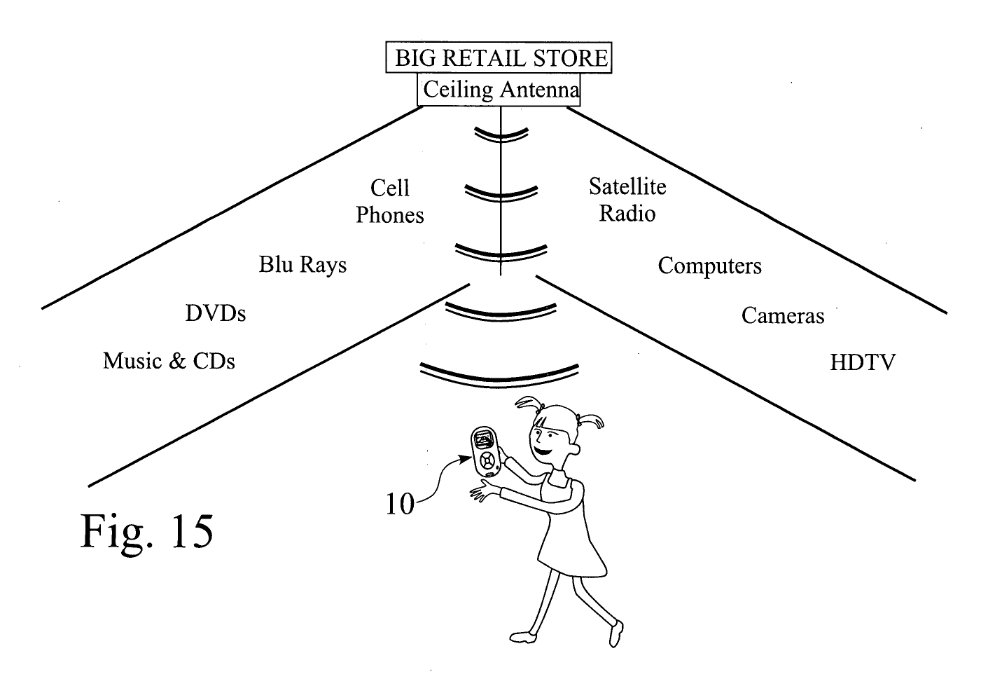

FIG. 15 shows the inside of a large retail store. In one embodiment of the invention, the present invention may be used to receive a generally continuous stream of content that is related to products for sale in the retail store.

### VI: Alternative Embodiment: Watchman™ NanoCaster™

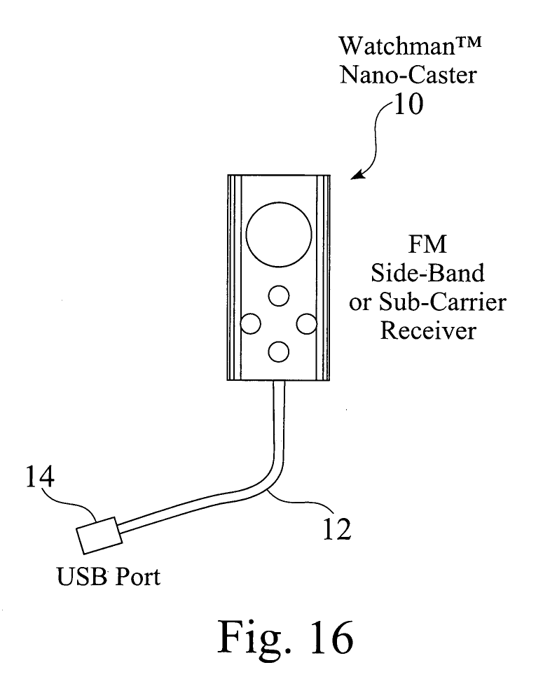

FIG. 16 furnishes a view of an alternative embodiment, a Watchman™ NanoCaster™, which includes a radio receiver and a USB port. This embodiment is intended for a user who already has an information appliance or terminal such as a cellular telephone, PDA, iPod, or some other suitable device. The radio receiver is configured to receive signals using the RainBarrel™ Method as described in Sections II and III of this Specification. The radio receiver is connected to the information appliance using a USB connector, or by using some other suitable connector that is capable of being connected to the information appliance.

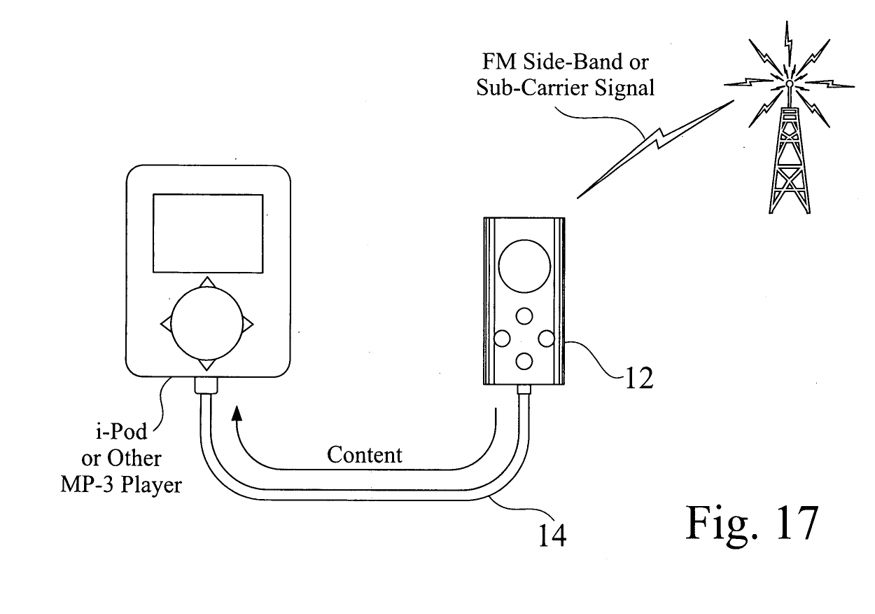

FIG. 17 shows how a NanoCaster™ may be connected to an iPod or other MP3 or MP4 player.

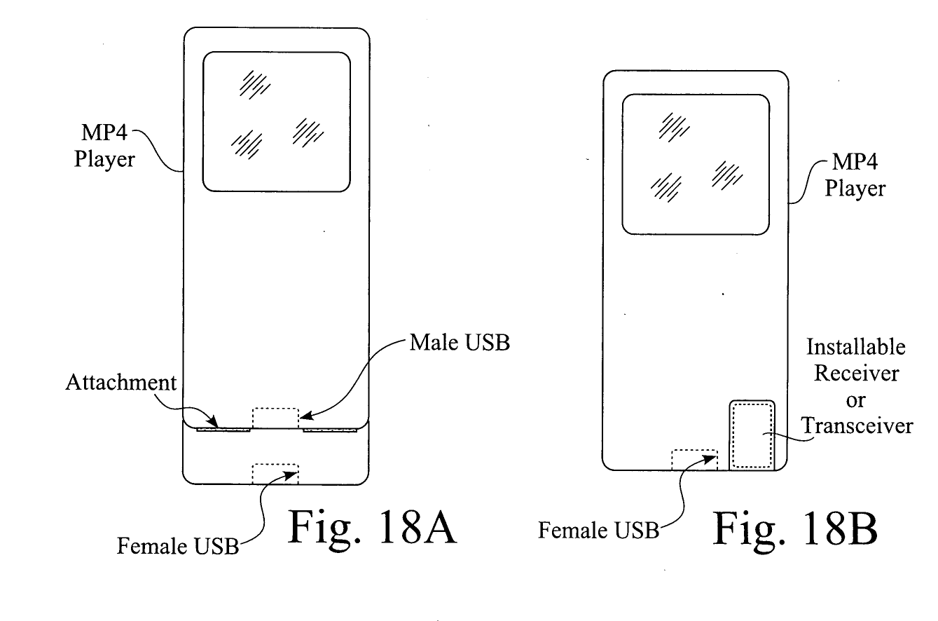

FIG. 18 reveals an alternative embodiment of the NanoCaster™, which includes an integrated radio receiver that may be affixed to the information appliance using adhesive or some other suitable means. A female USB port is provided at the base of this embodiment for connections to other sources of content or power.

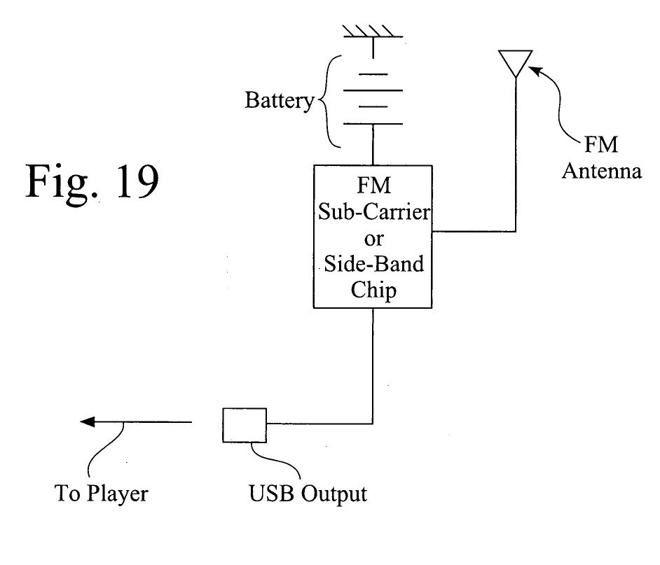

FIG. 19 is a schematic diagram of one embodiment of the NanoCaster™.

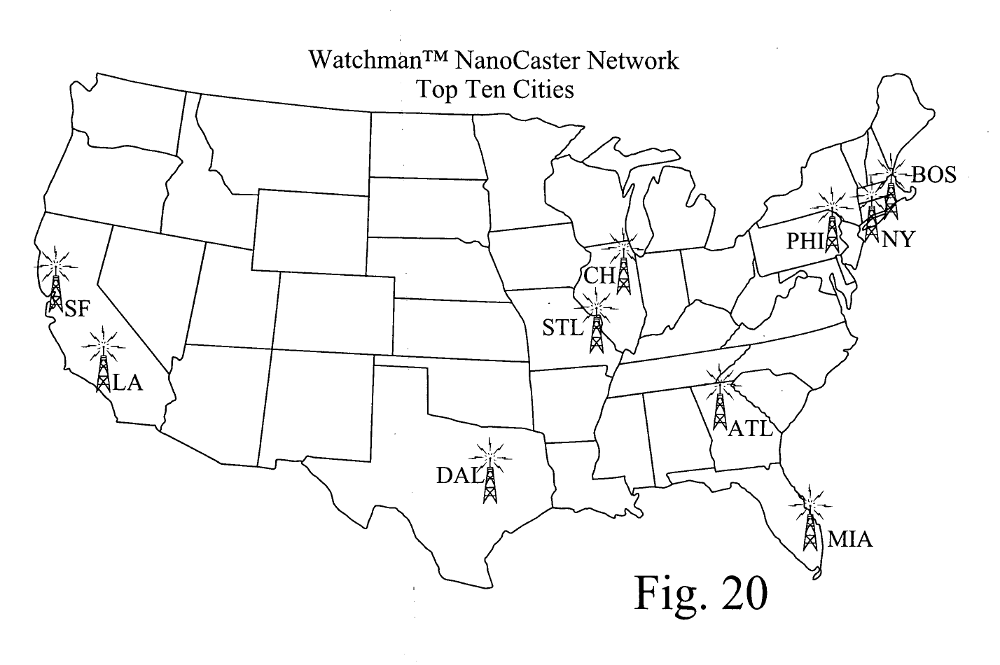

FIG. 20 offers a view of a nationwide NanoCaster™ Network.

### VII. Alternative Embodiment: Two-Way Watchman™

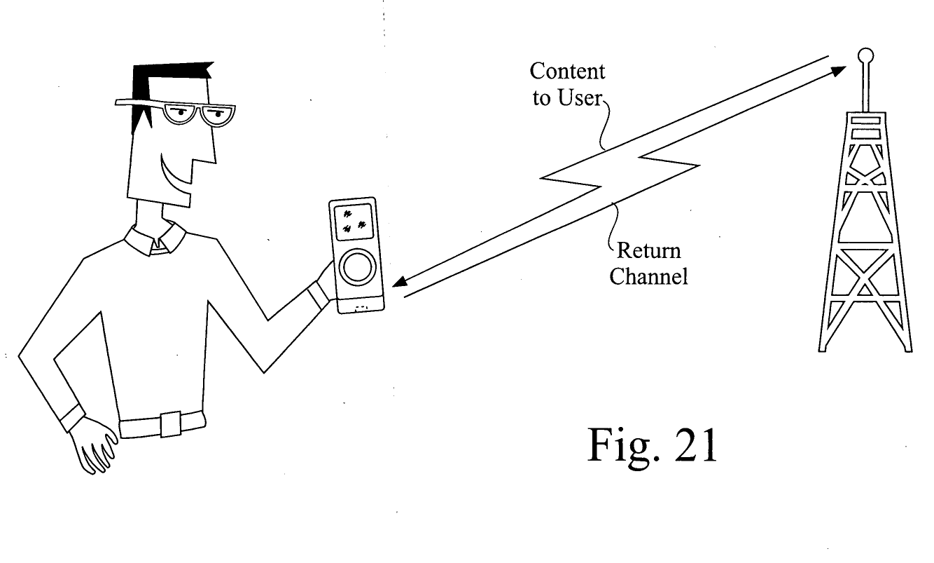

FIG. 21 depicts another embodiment of the invention, which includes a return channel that is provided for low-power bursts of short messages. A Two-Way Watchman™ may be used to report periodically to its sponsor concerning the viewing of content by the user. This embodiment offers a Watchman™ that reports periodically to its sponsor concerning the content that has been viewed.

As an example, a restaurant chain may sell or give away a Two-Way Watchman™ to their customers. The customer may watch a combination of content and advertising that is provided over the channel from a transmitter to the Two-Way Watchman™. A sponsor, who selects and provides the content and/or advertising, may also insert promotions, offers or questions for the user. The user may then respond using the return channel. The return channel may also be implemented using a regional or nationwide paging or cellular telephone company. This embodiment may be implemented using a wireless link, or by using an RFID-like reader at the portal to the sponsor's business, or by any other suitable means.

In one embodiment of the invention, it may be necessary to alter or to add software to the information appliance to enable the user to receive the content and/or advertising. This may be accomplished by downloading software from the Internet, or by adding a new SIM or memory card to the information appliance.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a highly secure data distribution system that have been disclosed above are intended to educate the reader about preferred embodiments of the invention, and are not intended to constrain the limits of the invention or the scope of Claims. The List of Reference Characters which follow is intended to provide the reader with a convenient means of identifying elements of the invention in the Specification and Drawings. This list is not intended to delineate or narrow the scope of the Claims.

### LIST OF REFERENCE CHARACTERS

10 Personal Content Player
12 Housing
14 Viewing screen
15 Speaker
16 User controls
17 Headphone jack
18 Battery compartment
20 Content provider or aggregator
22 Radio station or other transmitter
24 Stream of broadcast content
26 Main broadcast signal
28 Subcarrier or sideband
30 Batteries
32 CPU
33 Radio receiver
34 Antenna
36 External memory socket
38 External memory
41 Block diagram of enhanced embodiment
40 Internal memory
42 Enhanced user controls
44 Bluetooth chip
46 Internal rechargeable battery
48 Free Watchman™ with purchase of fast food meal
50 Free Watchman™ with purchase of movie ticket
52 Free Watchman™ at retail checkout
54 Block diagram showing one method of the invention
56 Content creators
58 Manufacturer
60 Advertising agency
62 Sponsor/Distributor
64 Mix of free content and advertising
65 Solar cell

What is claimed is:

1. A method comprising the steps of:
uploading content to a content aggregator (20);
providing a wireless receiver (10) to a sponsor (62);
providing an advertisement to a sponsor (62);
distributing said wireless receiver (10) to a user;
broadcasting said content and said advertisement using the excess capacity in a radio transmitter (22) to said user;
accumulating said content and said advertisement in said wireless receiver (10); and
reproducing said content and said advertisement at a time chosen by said user.

2. A method as recited in claim 1, in which said content aggregator (20) is a website.

3. A method as recited in claim 1, in which said receiver (10) includes
a housing (12);
a viewing screen (14); said viewing screen (14) being mounted on said housing (12);
a user control (16); said user control (16) being mounted on said housing (12);
a battery compartment (18); said battery compartment being mounted within said housing (12);
a central processing unit (32); said central processing unit (32) being mounted within said housing (12); said central processing unit (32) being connected to said battery compartment (18);
a radio receiver (33); said radio receiver (33) being mounted within said housing (12); said radio receiver (33) being connected to said central processing unit (33);
an antenna (34); said antenna (34) being connected to said radio receiver (32); and
an external memory socket (36); said external memory socket (36) being mounted so that it extends through said housing (12); said external memory socket (36) being connected to said radio receiver (33).

4. A method as recited in claim 3, in which said receiver (10) further includes an internal memory (40).

5. A method as recited in claim 3, in which said receiver (10) further includes a transmitter chip (44).

6. A method as recited in claim 3, in which said receiver (10) further includes an internal rechargeable battery (46).

7. A method as recited in claim 1, in which said sponsor (62) is a restaurant.

8. A method as recited in claim 1, in which said sponsor (62) is a retailer.

9. A method as recited in claim 1, in which said sponsor (62) is a movie studio.

10. A method as recited in claim 1, in which said sponsor (62) is a theater.

11. A method as recited in claim 1, in which said sponsor (62) is a film distributor.

12. A method as recited in claim 1, in which said receiver (10) is distributed to said to said user free of charge.

13. A method as recited in claim 1, in which said user supplies a battery for said receiver (10).

14. A method as recited in claim 1, in which said user supplies an external memory (36) for said receiver (10).

15. A method as recited in claim 1, in which said radio transmitter (22) is an AM radio station.

16. A method as recited in claim 1, in which said radio transmitter (22) is an FM radio station.

17. A method as recited in claim 1, in which said radio transmitter (22) is a cellular telephone transmitter.

18. A method as recited in claim 1, in which said radio transmitter (22) is a Wi-Fi transmitter.

19. A method as recited in claim 1, in which said radio transmitter (22) is a WiMAX transmitter.

20. A method as recited in claim 1, in which said radio transmitter (22) is a satellite.

21. A method as recited in claim 1, in which said content is conveyed using a sideband.

22. A method as recited in claim 1, in which said content is conveyed using a subcarrier.

23. A method as recited in claim 1, further comprising a speaker (15); said speaker (15) being mounted on said housing (12).

24. A method as recited in claim 6, in which said internal rechargeable battery (46) is recharged using said external memory socket (36).

25. A method as recited in claim 6, in which said internal rechargeable battery (46) is recharged using a solar cell (65).

26. A method as recited in claim 1, in which said content is encrypted.

27. A method as recited in claim 1, in which said advertisement is encrypted.

28. A method comprising the steps of:
uploading content to a content aggregator (20);
providing a wireless receiver (10) to a sponsor (62);
distributing said wireless receiver (10) to a user;
broadcasting said content using the excess capacity in a radio transmitter (22) to said user;
accumulating said content in said wireless receiver (10); and
reproducing said content at a time chosen by said user.

29. An apparatus comprising:
a housing (12);
a viewing screen (14); said viewing screen (14) being mounted on said housing (12); said viewing screen (14) for displaying a stream of video content provided to a user free of charge;
a speaker (15); said speaker (15) being mounted on said housing (12);
a user control (16); said user control (16) being mounted on said housing (12);
a battery compartment (18); said battery compartment being mounted within said housing (12); said user providing a battery for said battery compartment (18);
a central processing unit (32); said central processing unit (32) being connected to said battery compartment (18);
a radio receiver (33); said radio receiver (33) being mounted within said housing (12); said radio receiver (33) being connected to said central processing unit (32) and said battery compartment (18); said radio receiver (33) being configured to only receive a stream of content which is broadcast using the excess capacity in a network; said content being automatically conveyed to said radio receiver (33) using said excess capacity;
an antenna (34); said antenna (34) being connected to said radio receiver (33);
an external memory socket (36); said external memory socket (36) being mounted so that it extends through said housing (12); said external memory socket (36) being connected to said radio receiver (33); said user providing an external memory (38) which attaches to said external memory socket (36); and
a headphone jack (17); said headphone jack (17) being connected to said central processing unit (32).

30. A method comprising the steps of:
providing a transmitter (22) on a retail store;
distributing a plurality of terminals (10) to a plurality of customers of said retail store; and
operating a private television distribution system by pushing a stream of free content from said transmitter (22) to said plurality of terminals (10) used by said customers of said retail store; said plurality of terminals being tuned to receive said stream of free content.

31. A method as recited in claim 30, in which said stream of free content is related to a plurality of products offered for sale in said retail store.

32. A method as recited in claim 1, in which said content is protected using a key protection system.

33. A method as recited in claim 32, in which said key protection system is a Bilateral UltraSecure^{SM} System.

34. A method as recited in claim 1, in which said wireless receiver (10) includes a return channel.

35. A method as recited in claim 1, in which the step of broadcasting said content and said advertisement using the excess capacity in a radio transmitter (22) to said user is augmented by transmitting a backup signal that may be used to fill in missing data due to a signal drop-out.

36. A method comprising:
providing a wireless receiver for receiving a broadcast of content and advertisement using the excess capacity in a radio transmitter to a user;
providing a connector for said wireless receiver; and
connecting said connector to an information appliance to provide said stream of content and advertisement to said information appliance.

37. A method as recited in claim 36, including the step of:
altering software resident on said information appliance to enable the user to receiver said content and advertising.
